(19) United States
(12) Patent Application Publication
(10) Pub. No.: US 2007/0146806 A1
(43) Pub. Date: Jun. 28, 2007

(54) Image processing apparatus, image processing method and program

(75) Inventor: Masaya Ishihara, Chiba (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/586,885

(22) Filed: Oct. 25, 2006

(30) Foreign Application Priority Data
Dec. 28, 2005 (JP) 2005-379584

(51) Int. Cl. H04N 1/00

(52) U.S. Cl. 358/405

(57) ABSTRACT

An image processing apparatus is provided which is capable of adding specific image information for only cases to which addition is desired and of outputting the specific image information added image when adding the specific image information used to prohibit copying of image information to image data. The image processing apparatus comprises a specific image information adding portion which adds one or more sets of specific image information representing a specific image to image data input from various image input portions. Various image recording portions such as printing portion record the image data which has been added with the specific image information by the specific image information adding portion on a recording medium such as recording paper sheet. The specific image information adding portion makes the state after the adding process different depending upon the input source in the image input portion and/or recording destination in the image recording portion.

### CROSS-NOTING PARAGRAPH

This Nonprovisional application claims priority under 35 U.S.C. §119(a) on Patent Application No. 2005-379584 filed in JAPAN on Dec. 28, 2005, the entire contents of which are hereby incorporated herein by references.

### FIELD OF THE INVENTION

The present invention relates to an image processing apparatus, an image processing method, and a program, and, more particularly, relates to an image processing apparatus and an image processing method that can add specific image information to image data to prohibit copying thereof, and a program incorporated into the apparatus to add the specific image information.

### BACKGROUND OF THE INVENTION

In order to prevent unauthorized copying of original printed documents, techniques which add specific image information such as background pattern when the original document is printed have been used. This specific image information is often referred to as “copy preventing information” or “anti-copy information”.

For example, when image data is fed from an application running on a personal computer to a printer for printing out the image data from the printer, specific image information which prevents the copying of the image to be printed is fed to the printer together with the above image data, and the printer embeds the specific image information somewhere in the printed image for printing out. When trying to copy the printed image in which the specific image information is embedded, the copy machine which has detected the specific image information will not output the copy printing or executes an operation such as outputting by printing such as “Copy Prohibited”.

The above-mentioned specific image information may be embedded in printed image in the way that it cannot be recognized by the user, or may be embedded, for discouraging the copying, in the way that it can be recognized by the user that it is the specific image information. In either case, the copy machine detects the presence of the specific image information in the image information when the image information in which the specific image information is embedded is copied and conducts predetermined processing, for example, stopping of the copying per se or outputting of a copied image having characters such as “Copy Prohibited” in response to a detection result.

In connection with the technique for prohibiting unauthorized copying, a copy machine which is capable of easily making an original document bearing specific pattern thereon is disclosed in, for example, Japanese Laid-Open Patent Publication No. H7-38737. The copy machine comprises a generating means for generating specific marks for reproducing the image with adding the specific marks to an original document image; a mark detecting means for detecting the presence of the specific marks in read original document image; and a control means which conducts the copying operation which is different from usual copying operation if the specific mark in the original document image is detected by said mark detecting means.

A copy machine which obtains a reproduced image which makes it possible to detect the specific marks in an easy and precise manner is disclosed in Japanese Laid-Open Patent Publication No. H7-36325. This copy machine has a capability of reproducing an image to which specific marks are added by a mark adding means. The mark adding means adds specific marks, each comprising a plurality of concentric circles having different diameters, to the original document image.

Besides the technologies of Japanese Laid-Open Patent Publication Nos. H7-38737 and H7-36325, the methods of adding the specific image information include a method of mixing information in a frequency area as is the case of a digital watermark, a method of adding a bar-code, etc., to a non-image area, a method of adding information such as a watermark to an image area, etc.

However, in a system of such conventional art, when a printed image is read to detect whether specific image information is included, misrecognition is increased depending on characteristics of the printed image. For example, even though the specific image information is not printed on an original document, when the original document is copied, a characteristic of the original document may coincide with a characteristic of the specific image information and stop the print operation. Even if a characteristic of the original document does not coincide with the specific image information, when the original document is repeatedly copied many times, scratches may be formed and so-called trash or foreign particles may be printed, which may coincide with a characteristic of the specific image information and stop the print operation, even though the specific image information is not printed on the original document. The detection accuracy of the specific image information is varied depending on usage patterns of a user and the information may not be detected in some cases.

It can be envisaged that setting of addition/non-addition of specific image information for each print or copy is made by a user and/or setting of the specific image information to be added is made different by a user. Various cases in which setting should be conducted may include a case in which original documents are copied, a case in which printing is carried out from an external personal computer, a case in which printing is carried out on facsimile reception, and a case in which image data stored in an apparatus is printed. Setting of specific image information by a user depending upon each print form of digital multifunction peripheral is cumbersome. Therefore, another approach in which specific image information is added in all cases has been adopted as an alternative method.

Printing of specific image information in unnecessary cases will consume valuable toners or ink. Setting of the specific image information for each case will often cause failure of addition of the specific image information. If cases are freely discriminated and determination whether or not the specific image information is added is made based on the discrimination, the specific image information would not be added in necessary cases, or it would be added in unnecessary cases, resulting in a wasting of toners or ink.

### SUMMARY OF THE INENTION

It is an object of the present invention to provide an image processing apparatus, an image processing method and a program incorporated in said apparatus, which is capable of adding specific image information for only cases to which the specific image information is desired to be added and of outputting images which are added with the specific image information when the specific image information used to prohibit copying of the image information is added to the image data.

More specifically, it is an object of the present invention to provide an image processing apparatus comprising: an image input portion for inputting image data; a specific image information adding portion for adding one or more sets of specific image information representing a specific image when the image data input from said image input portion is subjected to image processing; and an image recording portion for recording on a recording medium the image data which has been added with said specific image information at said specific image information adding portion, wherein said specific image information adding portion makes a state after an adding process different depending upon an input source in said image input portion and/or a recording destination in said image recording portion.

It is another object of the present invention to provide an image processing apparatus, wherein said specific image information adding portion makes said state after said adding process different depending upon whether or not said specific image information is to be added.

It is a further object of the present invention to provide an image processing apparatus, wherein said specific image information adding portion makes one or more of a color, number and position of said specific image information different as said state after said adding process.

It is a further object of the present invention to provide an image processing apparatus, wherein said specific image information adding portion makes a kind of said specific image information different as said state after said adding process.

It is a further object of the present invention to provide an image processing apparatus, wherein said state after said adding process is determined based upon the importance of the image data input at said image input portion.

It is a further object of the present invention to provide an image processing apparatus, wherein said image recording portion includes a proxy processing portion which requests other image processing apparatus connected to said image processing apparatus to execute recording when said image recording portion is not able to execute said recording by itself, said proxy processing portion being adapted to select said other image processing apparatus from a plurality of image processing apparatuses based upon said input source.

It is a further object of the present invention to provide an image processing apparatus, wherein said image recording portion includes a proxy processing portion which requests other image processing apparatus connected to said image processing apparatus to execute recording when said image recording portion is not able to execute said recording by itself, said specific image information adding portion being adapted to execute said addition of said specific image information regardless of a recording destination to which said proxy processing portion requests said recording.

It is a further object of the present invention to provide an image processing apparatus, wherein if a plurality of recording destinations are set in said image recording portion to one piece of the image data input at said input portion, said specific image information adding portion being adapted to make said state after said adding process common among said plurality of recording destinations.

It is a further object of the present invention to provide an image processing apparatus, wherein said image recording portion includes an image storing portion for storing in a recording medium the image data input at said image input portion, said specific image information adding portion being adapted to add said specific image information to the image data stored in said image storing portion so that said image data and said specific image information is stored as one set of information in said image storing portion.

It is a further object of the present invention to provide an image processing apparatus, wherein said apparatus comprises a specific image information setting portion which sets said state after said adding process for each of said input sources and/or said recording destinations, said specific image information adding portion executing the addition of said specific image information based upon setting at said specific image information setting portion.

It is a further object of the present invention to provide an image processing method in an image processing apparatus comprising an image input portion for inputting image data; an image processing portion which applies an image process to the image data; and an image recording portion for recording the image data on a recording medium, wherein said method includes the steps of: an image input step for inputting the image data by said image input portion; a specific image information adding step for adding one or more sets of specific image information representing a specific image when said image processing portion applies said image process to the image data input at said image input step; and an image recording step for recording the image data which is added with said specific image information at said specific image information adding step on a recording medium by means of said image recording portion, wherein a state after an adding process is made different depending upon an input source in said image input portion and/or a recording destination in said image recording portion at said specific image information adding step.

It is a further object of the present invention to provide a program which is incorporated in said image processing apparatus to cause a processing unit in said image processing apparatus to function as said specific image information adding portion or said specific image information adding portion and said specific image information setting portion.

### BRIEF DESCRIPTION OF THE DRAWINGS

FIG. 1 is a block diagram for explaining the exemplary configuration of a digital multi-function peripheral to which an image processing apparatus of the present invention is applied;

FIG. 2 is a block diagram showing only the configuration which is mainly concerned with the present invention in the image processing apparatus;

FIG. 3 is a block diagram showing an exemplary configuration of a determining portion in the image processing apparatus of FIG. 2;

FIGS. 4A and 4B are views showing examples of specific images information which are added in the image processing apparatus of FIG. 1;

FIG. 5 is a view showing an example of an operation portion in the image processing apparatus of FIG. 1;

FIG. 6 is a view showing an exemplary screen displayed in a display portion in the image processing apparatus of FIG. 1;

FIG. 7 is a view showing an exemplary screen displayed in a display portion in the image processing apparatus of FIG. 1;

FIG. 8 is a view showing an exemplary screen displayed in a display portion in the image processing apparatus of FIG. 1;

FIG. 9 is a view showing an exemplary screen displayed in a display portion in the image processing apparatus of FIG. 1;

FIG. 10 is a view showing an exemplary screen displayed in a display portion in the image processing apparatus of FIG. 1;

FIG. 11 is a view showing an exemplary screen displayed in a display portion in the image processing apparatus of Fig.

FIG. 12 is a flow chart explaining an example of a specific image information adding process in the image processing apparatus of FIG. 1; and

FIG. 13 is a view showing an exemplary configuration of a typical image processing apparatus.

### PREFERRED EMBODIMENTS OF THE INVENTION

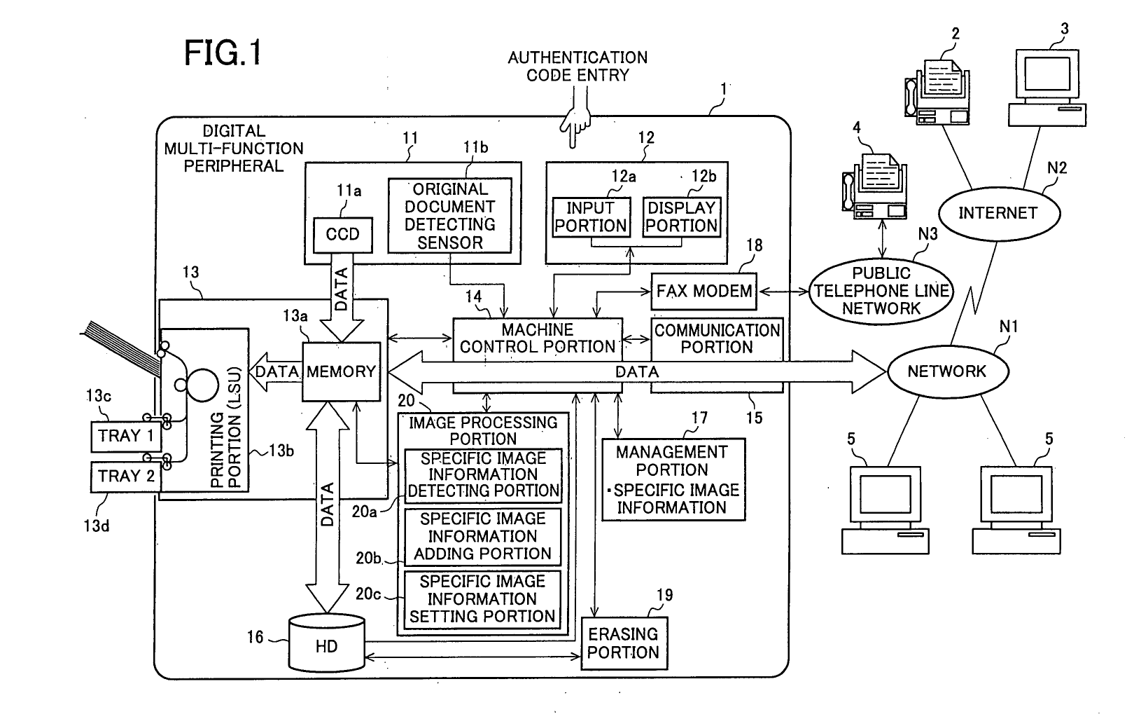

FIG. 1 is a block diagram for describing a configuration example of a digital multi-function peripheral (compound machine) to which an image processing apparatus of the present invention is applied. A digital MFP (multi-function peripheral) 1 exemplified in FIG. 1 is an MFP including functions of a copy machine, printer apparatus, facsimile apparatus, and scanner apparatus.

The digital MFP 1 comprises a machine control portion 14 including a CPU which performs arithmetic operations and a RAM and the like which store temporal information in association with the arithmetic operations. A ROM which stores a control program for controlling the digital MFP 1 is included in the machine control portion 14. A management portion 17 which is a memory storing management information (various items of control information) for managing the processing conducted by the digital MFP 1 is connected to the machine control portion 14.

An operation portion 12, as an example of a user operation portion, which accepts operations by the user and input them is connected to the machine control portion 14. The operation portion 12 comprises an input portion 12a such as a touch panel or ten-key pad from which information such as a control instruction is entered by the operation of the user, and a display portion 12b such as a liquid crystal panel which displays information necessary for the operation. Further, authentication codes which authenticate the administrator or user (i.e., operator) of the present digital MFP 1 are entered into the operation portion 12. In some cases, the authentication codes may be entered from an external device via the FAX modem 18 or communication portion 15.

An image-reading portion 11, as one of image input portions, which reads images recorded on a recording paper sheet to generate image data is connected to the machine control portion 14. The image reading portion 11 is provided with a CCD 11a for reading original document images as image data and an original document detecting sensor 11b which detects the presence or absence of the original document.

An image forming portion 13, as one of image recording portions, which forms image data on a recording paper sheet is connected to the machine control portion 14. The image forming portion 13 is provided with a memory 13a for temporarily storing the image data, a printing portion (LSU) 13b which forms images from the image data stored by the memory 13a for recording them on a recording paper sheet, and sheet trays 13c, 13d from which recording paper sheets are fed for the image formation at the printing portion 13b. The digital MFP 1 can form images at the printing portion 13b after the image data generated by the image reading portion 11 are stored on the memory 13a once. In such a manner, the digital MFP 1 functions as a copy machine.

A FAX modem 18, as one of image input portions, which conducts facsimile communication is connected to the machine control portion 14 exemplified in FIG. 1. The FAX modem 18 is also connected to a public telephone line network N3. The digital MFP 1 is capable of receiving the image data transmitted from the other facsimile apparatus 4 via the public telephone line network N3 at the FAX modem 18 to form images from the received image data at the image forming portion 13. The digital MFP 1 is also capable of transmitting the image data which is generated by the image reading portion 11 to another facsimile apparatus 4 via the public telephone line network N3 which is connected to the FAX modem 18 by the facsimile communication. In this case, the FAX modem functions as one of image recording portions that record the image data on the external facsimile apparatus 4. In such a manner, the digital MFP 1 also functions as a facsimile apparatus.

A communication portion (transceiver portion) 15 which enables the digital MFP 1 to transmit/receive information to/from an external source is connected to the machine control portion 14. The communication portion 15 can be connected to a communication network N1 such as intra-LAN. One or more personal computer(s) (PC(s)) 5 can be connected to the communication network N1. In a usual situation at which the digital MFP 1 is operated alone, the communication portion 15 is connected to the communication network N1 for exchanging information with PC(s) 5 via the communication network N1.

The digital MFP 1 is capable of transmitting image data which is generated by the image reading portion 11 to PC 5 from the communication portion 15. Thus, the digital MFP 1 functions as a scanner apparatus. Further, the digital MFP 1 is capable of receiving the image data transmitted from PC 5 at the communication portion 15 for forming images from the received image data at the image forming portion 13. Thus, the digital MFP 1 serves as a printer apparatus.

The communication network N1 is connected to a wide area communication network N2 such as the Internet. The communication portion 15 is capable of receiving image data from the Internet facsimile apparatus 2 or an external PC 3 which is connected to the wide area communication network N2 via the communication network N1 and wide area communication network N2 through techniques such as transmitting image data with attaching them to an electronic mail. Thus, the digital MFP 1 also serves as an Internet facsimile apparatus.

In such a manner, the communication portion 15 functions as one of the image input portions when the digital MFP 1 receives image data from an external device and functions as one of the image recording portions when the digital MFP 1 transmits the image data to the external device.

A hard disk (HD) 16 is connected to the machine control portion 14. The hard disk 16 stores therein the image data which is related with image processes such as image data which is generated by the image reading portion 11. The digital MFP 1 does not conduct image forming of the image data input via various paths in the image forming portion 13, but functions as an image storing apparatus by causing the hard disk (HD) 16 to store the image data. An erasing portion 19 is connected to the machine control portion 14. The erasing portion 19 is adapted to erase the data which is recorded on and retained in the hard disk under control of the machine control portion 14.

An image processing portion 20 which implements processing to add specific image information concerning to the preset invention is connected to the machine control portion 14. The image processing portion 20 may preferably include an image modifying portion (not shown) which executes a modifying process to image data which is input from the above-mentioned various image input portions for modifying the image represented by the image data. The image modifying portion may be an image magnification changing portion, a portion for changing the density of the image represented by image data input from the image input portion, a portion for rotating the orientation of the image, and so on.

The image modifying portion may preferably comprise an image magnification changing portion which executes an image magnification process to the image data input from the image input portion for changing the magnification of the image which is represented by the image data. The image magnification changing portion carries out the magnification changing process based upon one of magnification changing setting for specified magnification factor, magnification setting for specified paper size, setting for binding margin (including indirect setting for front cover), collective setting which is also referred to as “n in 1” and divided setting which are input by a user's operation in the operation portion 12. The image magnification changing portion is generally included in usual copying machines. The image magnification changing function may also be preferably carried out when image data is stored in or transmitted to the HD 16 and/or external devices.

The image processing portion 20 includes a specific image information adding portion 20b for implementing processing to add specific image information in accordance with the present invention. The specific image information adding portion 20b is a portion that adds one or plural items of specific image information representing a specific image to the image data input via various image input portions. The specific image information adding portion 20b adds specific image information after the image modifying process is conducted in the above-mentioned image modifying portion, and therefore predetermined specific image information is able to be added irrespective of processing such as magnification change or rotation and detection of the specific image information becomes easy.

In some cases, for example, cases where the image modification changing portion does not have a process corresponding to a process for the magnification of 1, the image modifying portion does not modify the image. In those cases, the processing may not be conducted through the image modifying portion or a part of the processing may be conducted through the image modifying portion. The above-mentioned various image recording portions record on a recording medium the image data which has been added with specific image information at the specific image information adding portion 20b.

Specifically, the specific image information adding portion 20b preliminarily retains specific image information to be added to the image data (or makes other accessible memory to retain it), and adds the specific image information to the image data under control related with addition of the specific image information by the machine control portion 14 and causes the memory 13a to retain the information added image data. If the image forming portion is used as the image recording portion, the image data which is processed by the image processing portion 20 is in the form of print data which is ultimately output from a printing portion 13b. If an image modifying process such as image magnification changing process is conducted, the image data which is input via, for example, the image input portion is saved in the HD 16. The saved image data is subjected to the image modifying process on a work memory, transferred to a page memory of the memory 13a, combined with the specific image information on the page memory, and printed at the printing portion 13b.

If specific image information such as “copy prohibition” is added to image data of an original document, a specific image which is generated in the specific image information adding portion 20b (which may be referred to as “specific image generating portion”) is added to image data which has been subjected to processing such as magnification changing and rotation of the image at the image processing portion 20, and the image data is preferably subjected to an image recording process such as printing. It is possible to add specific images to the image data of the original document on scanning of laser by providing a laser scanning circuit in a laser printer with the specific image information. In this case, the specific image information adding portion 20b functions as a portion that transmits the specific image information to the laser scanning circuit.

The specific image information adding portion 20b which is a main feature of the present invention makes a state after an adding process different depending upon an input source at the image input portion and/or a recording destination at the image recording portion. In order to make the state after the adding process different, the specific image information adding portion 20b may be preferably provided with a determining portion which determines the state after the adding process depending upon the input source and/or recording destination. The specific image information adding portion 20b adds specific image information to the image data so that the specific image information added image data becomes the state after the adding process, which is determined by the determining portion. The state after the adding process is preferably determined based upon the importance of the image data which is input at the image input portion.

In accordance with the present invention, it is necessary to provide a plurality of portions which are represented by the image input portion and/or image recording portion. A specific input source and specific recording destination which are used on processing will represent a function which is being used among those of the digital MFP 1. Accordingly, the present invention makes specific patterns different depending upon the currently executed function among those (printing, copying, facsimiling and saving of image data, etc.) of the digital MFP 1.

The specific image information adding portion 20b may make the state after the adding process different depending upon whether or not the specific image information is added. The specific image information adding portion 20b may make one or more of the colors, number and positions of items of specific image information different as the state after the adding process. The specific image information adding portion 20b may make the kinds of specific image information as the state after the adding process.

The specific image information is used for prohibiting copying as mentioned above (or for notifying a user of copy prohibition to discourage the user to copy). The specific image information may preferably be added in the way, for example, that yellow specific image information can not be viewed if the digital MFP is a color MFP. Black specific image information for which its density is adjusted may preferably be added in the way that it can not be viewed if the digital MFP is a monochrome MFP (or if the output is monochrome in a color MFP).

An example of concept of the difference in importance of each function will be described. The images which are transmitted by FAX are often monochrome and the location of the facsimile apparatus on the receiving side are not often identified. However, the important documents are generally transmitted after they are subjected to a process for maintaining confidentiality or confidentially transmitted. Therefore, images which are transmitted by FAX are expected to be less important. Some data which is to be printed by a printer may be a secret document which should not be leaked outside. Secret data such as accounting books may be printed. Documents to be copied may include signed contracts, and official documents, the confidentiality of which is expected to be the highest. Addition of the patterns of the specific image information may preferably be changed depending upon the image data input source. In this case, facsimile received documents may preferably be added with specific image information and documents which are requested to be printed by the printer may preferably be added with specific image information and documents which are read by a scanner for copying may preferably be added with specific image information.

In accordance with the present invention, it is possible to positively add specific image information only for cases where addition is desired when adding the specific image information used for prohibiting copying of image information to the image data as above. Addition of copy discouraging information to less important printed matters and failure to add copy discouraging information to highly important printed matters can be prevented by making addition/non-addition of the copy discouraging information different or by making the content of the discourage information (for example, the content of the specific image data which is made different depending upon its importance) different. As a result, positive copy discouraging is made possible.

The present invention includes a specific image information setting portion 20c which sets whether to add specific image information for which input source and recording destination, and sets the color, number and position of the specific image information if it is to be added as well as the specific image information adding portion 20b. In other words, the specific image information setting portion 20c sets the state after the adding process for each of input sources and/or recording destinations by defaults or user's choice on the operation portion 12 and is included, for example, in the image processing portion 20 as shown. The specific image information setting portion 20c presets a way of adding specific image information in accordance with the preset control by the machine control portion 14. The specific image information adding portion 20b adds the specific image information to image data based upon the way of adding which is set by the specific image information setting portion 20c for the preliminarily retained specific image information to be added to the image data.

A proxy processing portion may be included as the image recording portion in addition to the above. The proxy processing portion requests other image processing apparatus connected to the digital MFP 1 for substituting recording some or all of recording jobs (print jobs, etc.) if the digital MFP 1 is not able to execute recording by itself. The proxy processing portion selects some of a plurality of other image processing apparatuses based upon the input sources of the image data. Even if addition of specific image information is carried out by the specific image information adding portion 20b in this form, other image processing apparatus corresponding thereto can be selected. The specific image information adding portion 20b may carry out the addition of the specific image information irrespectively of the recording destination to which the proxy processing portion requests the proxy. In such a form, irrespective of the preset content of the other image processing apparatus (child apparatus on the other side), in other words, even if printing of the specific patterns by the child apparatus is prohibited, printing can be carried out in accordance with the printing conditions of the digital MFP 1 (parent apparatus).

If a plurality of recording destinations in the image recording portion are preset for one piece of image data input at the image input portion, for example, if one piece of image data is printed and saved in the HD 16, the specific image information adding portion 20b preferably makes the state after the adding process common among the plurality of recording destinations.

If the image storing portion is used as the image recording portion, when the specific image information is added to the image data to be stored in the image storing portion, the specific image information adding portion 20b preferably adds the specific image information so as to store the image data and specific image information as one set of information in the image storing portion. This will be exemplified with reference to saving of print data. If information of providing specific pattern exists together with image data when input image data is stored in a storing medium, the image data, specific pattern, and preferably providing information (information on how to add the specific image information to where) is saved as individual information (one set of information). This does not give any influence upon the specific pattern on processing such as changing of gradations if the image data is subsequently used for image processing.

In the setting and adding processes of the specific image information, the preferred implementations described above may be employed appropriately to perform the processes. For example, a predetermined pattern (specific pattern) image of the specific image information can be selected from single toner colors of YMCK, and a plurality of patterns with the same color or different colors may be added to one piece of output paper. When printing in a monochrome copying (FAX, printer) mode, a color of the additional pattern may be black, and when printing in a color mode, the color may be selected from four colors of YMCK. When a yellow pattern is selected, the pattern may be colored deeper or include larger dots as compared to the case of selecting a black pattern such that the pattern is detected even when recycled paper is used. When the image data are printed as a monochromatic binary format image, a density value of the additional pattern may be lower than a density value for printing the image data.

The predetermined pattern images may be added as at least M+N same images. When the patterns are actually detected, since an original document is recognized as an original document with additional information by detecting N patterns, only a part of the added patterns is needed to be detected and, therefore, the additional pattern can be an inconspicuous pattern. By reducing a primitive size of the additional printing pattern printed in black as compared to that of the pattern printed in yellow, the pattern can be detected when the pattern is printed on recycled paper and the pattern can be an inconspicuous, light and small pattern. The number of the additional pattern images may be varied depending on security strength.

On the other hand, the image processing portion 20 preferably comprises a specific image information detecting portion 20a which detects whether or not specific image information is included in the image data read by the image reading portion 11 and stored in the memory 13a. If the specific image information is included in the image data as a result of the detection by the specific image information detecting portion 20a, the machine control portion 14 performs control to prohibit copying of the image data (invalidate image forming at the image forming portion 13). For example, input image data such as image data read by the scanner is input to the image processing portion 20. It may be also input to the specific image information detecting portion 20a (also referred to as “specific image determining portion) where a specific image such as copy prohibited information is determined. If the specific image is detected, an image forming prohibition indicating circuit is preferably informed of the specific image, so that prohibition of image forming may be directed from the image forming prohibition indicating circuit.

In the present invention, the image processing portion 20, etc., preferably comprises an image invalidating portion in such a manner. In other words, this image invalidating portion is a portion that invalidates the image information read by the image reading portion 11 when the specific image information detecting portion 20a determines that the specific image information exists. Since some original documents bear complicated characters or output (output of print or FAX) portions also referred to as “trash”, it is preferable to preset and form predetermined images to be added at the specific image information setting portion so that M+N and more same patterns are added as above and that specific image information detecting portion 20a detects the image when M added patterns are recognized at the time of recognition. A number M may be determined by a percentage of the number of patterns to be added.

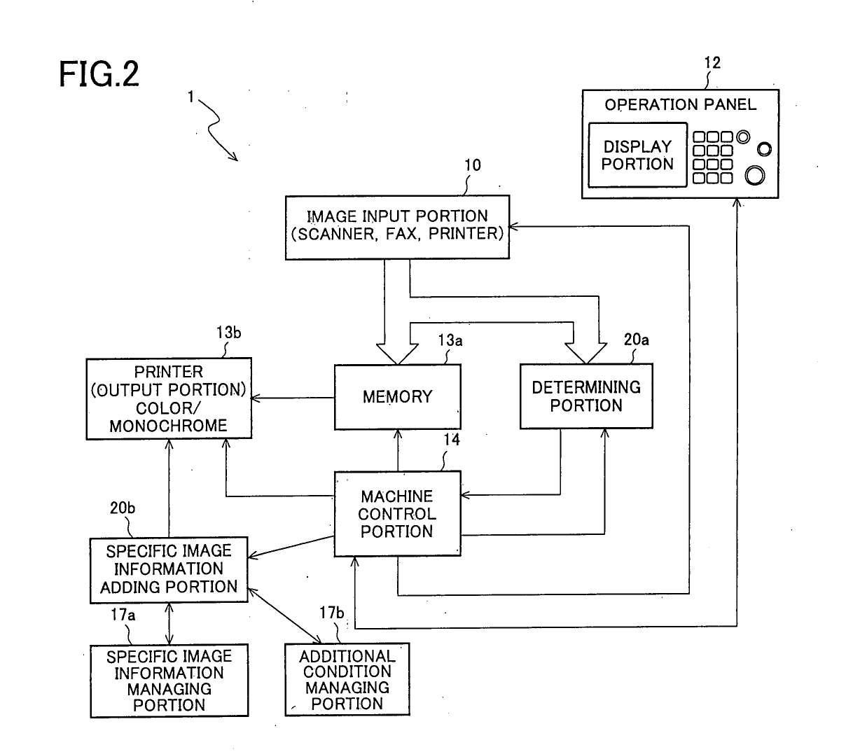

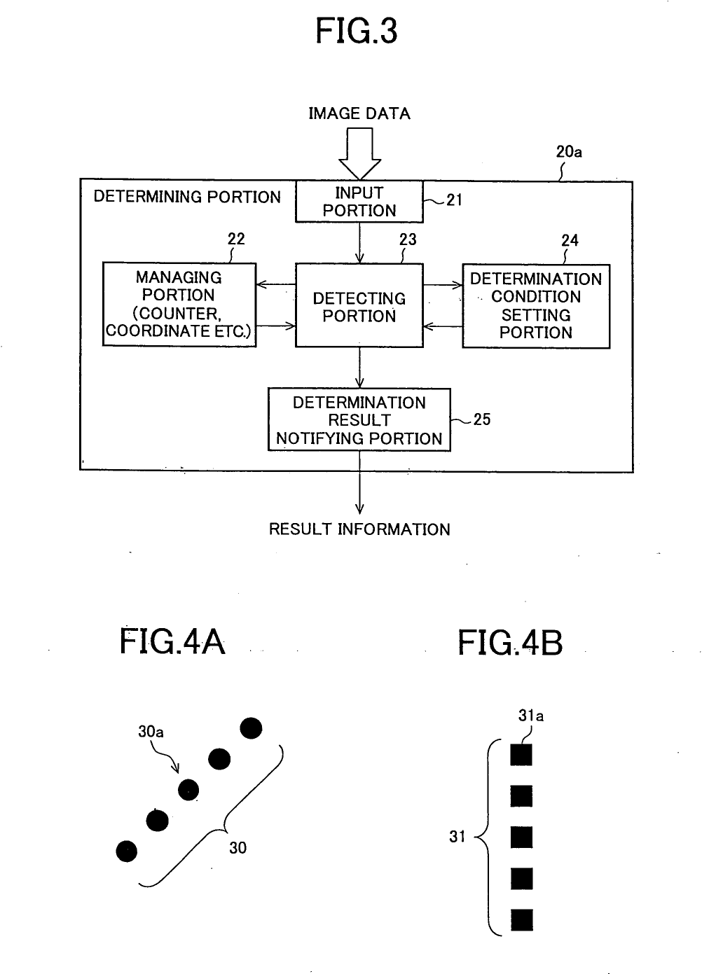

FIG. 2 is a block diagram showing only the configuration which is mainly concerned with the present invention in the image processing apparatus shown in FIG. 1. FIG. 3 is a block diagram showing an exemplary configuration of a determining portion in the image processing apparatus of FIG. 2. FIGS. 4A and 4B are views showing examples of the specific image information which is added in the image processing apparatus of FIG. 1. Addition and detection of specific image information in accordance with the present invention will be described in more detail with reference to FIGS. 2 through 4.

The digital MFP 1 mainly includes: an operation panel 12 for printing, etc., of an original document set by a user, for example; an image input portion 10 such as a scanner, FAX, and printer for inputting data of an original document; the memory 13a that temporarily stores the image data input at the image input portion 10; the specific image information detecting portion (determining portion) 20a that determines whether a specific image is output to (the specific image information is included in) the original document image data input at the image input portion 10 as well; the specific image information adding portion 20b that adds the specific image information to the image data stored in the memory 13a based on predetermined conditions (e.g., conditions of access right or process path); a specific image information managing portion 17a that stores one or a plurality of kinds of the specific image information to supply the specific image information adding portion 20b with a relevant kind of the specific image information when the specific image information adding portion 20b adds the information; an additional condition managing portion 17b (including the specific image information setting portion 20c) that sets the supply/no-supply of and stores the color, number, position, etc., (additional condition) of the specific image information supplied by the specific image information managing portion 17a; an output portion (printer 13b, etc.) that outputs the image data added (overlapped) with the specific image information added by the specific image information adding portion 20b based on the color, number, and position managed at and selected from the additional condition managing portion 17b when the image data stored in the memory 13a satisfy the aforementioned predetermined condition(s); and the machine control portion 14 that controls these components.

In such a configuration, the image processing portion 20 decompresses and processes input image data and stores and retains the processed image data in the image memory 13a as print executing data. In the image processing portion 20, the specific image information setting portion 20c sets whether to add specific image information and sets the color, number and positions of the specific images to be added. In the image processing portion 20, the specific image information which is set is added to the image data by means of the specific image information adding portion 20b based upon input sources and recording destinations which are set to be added, thereby generating the print executing data. The printer 13b conducts image forming on a recording paper sheet and the like by using the print executing data stored and retained in the image memory 13a.

Various patterns such as specific patterns 30 which are exemplarily shown in FIGS. 4A and 4B can be adapted as the specific image information to be added. The specific pattern 30 which is exemplarily shown in FIG. 4A is a pattern having 5 circular dots 30a which are equally spaced and diagonally arrayed at a given angle. The specific pattern 31 is a pattern having 5 rectangular dots 31a which are equally spaced and arrayed in a vertical direction. The dots may not be equally spaced. The number and arrangement of dots may be optionally determined. If a plurality of specific patterns are arrayed, the arrangement of the patterns may be optionally determined.

The determining portion 20a mainly includes: an input portion 21 that inputs image data; a detecting portion 23 that detects the specific image information from the input image data; a managing portion 22 that includes a counter counting the number of pieces of the specific image information detected by the detecting portion 23 to manage a count value, coordinates, etc.; a determination condition setting portion 24 that sets a determination condition (such as the number of pieces of the specific image information) in the detecting portion 23; and a determination result notifying portion 25 that determines whether the determination condition is satisfied by the number detected by the detecting portion 23 to notify the machine control portion 14 of the result information.

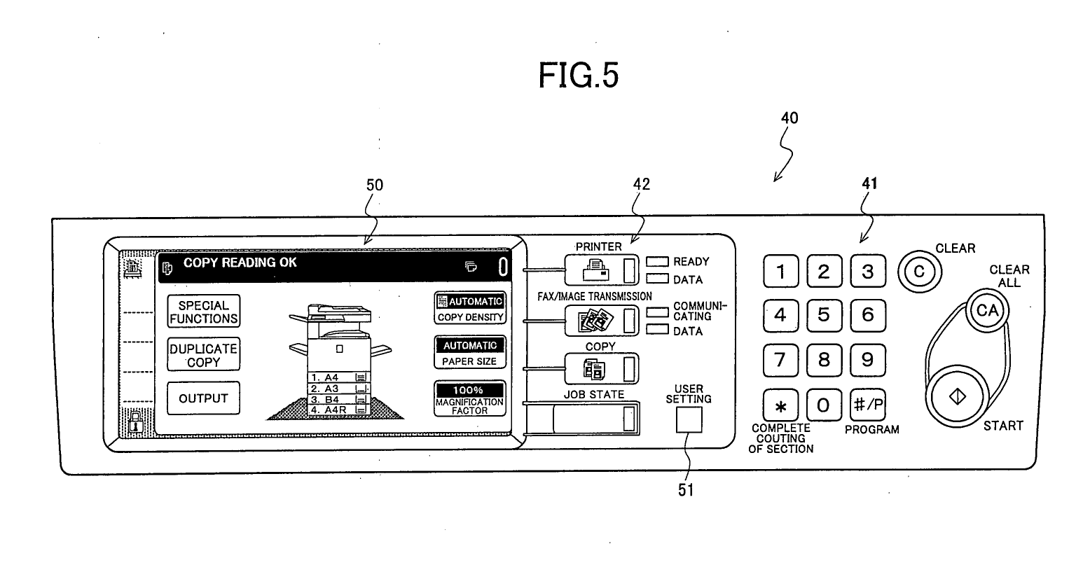

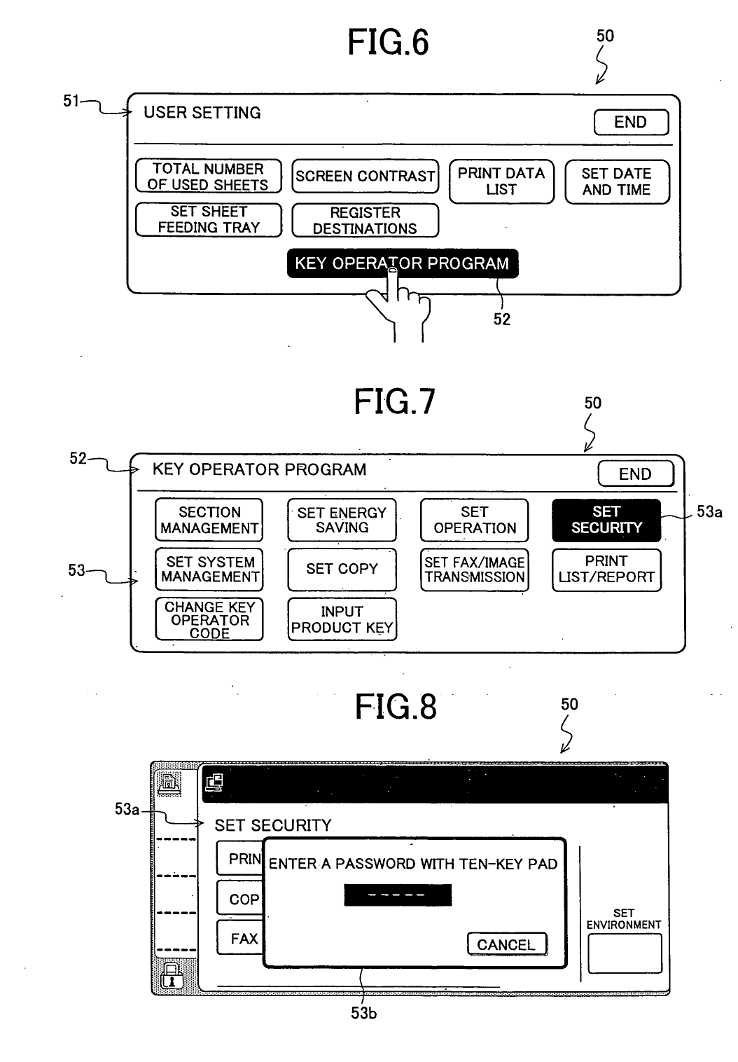

FIG. 5 shows an example of an operation portion of the image processing apparatus of FIG. 1. FIGS. 6 through 11 show examples of display screens displayed on a display portion in the image processing apparatus of FIG. 1. In the image processing apparatus (digital MFP 1) of FIG. 1, the user operation portion 12 is configured like an operation portion 40 in FIG. 5. A display screen 50 is displayed on the display portion 12b. The display screen 50 maybe preferably displayed using GUI (graphical user interface). The operation portion 40 may comprise buttons 42 for selecting the functions to be used such as printer, fax/image transmission and copy, a button for displaying a job state on the screen, a ten-key pad 41, a start key, a cancel key and a user setting button 51 for conducting user setting such as a setting in a specific image information setting portion 30c in addition to the touch panel for displaying the screen 50.

When a user depresses the user setting button 51 in the operation setting portion 40 in FIG. 5, a transition area 52 to a key operator program is displayed in addition to various settings like screen 50 in FIG. 6. A term “key operator program” means a program which can be set by only an administrator, that is a program for conducting setting which must not be changed by usual users, such as setting concerned with addition of the specific image of the present invention.

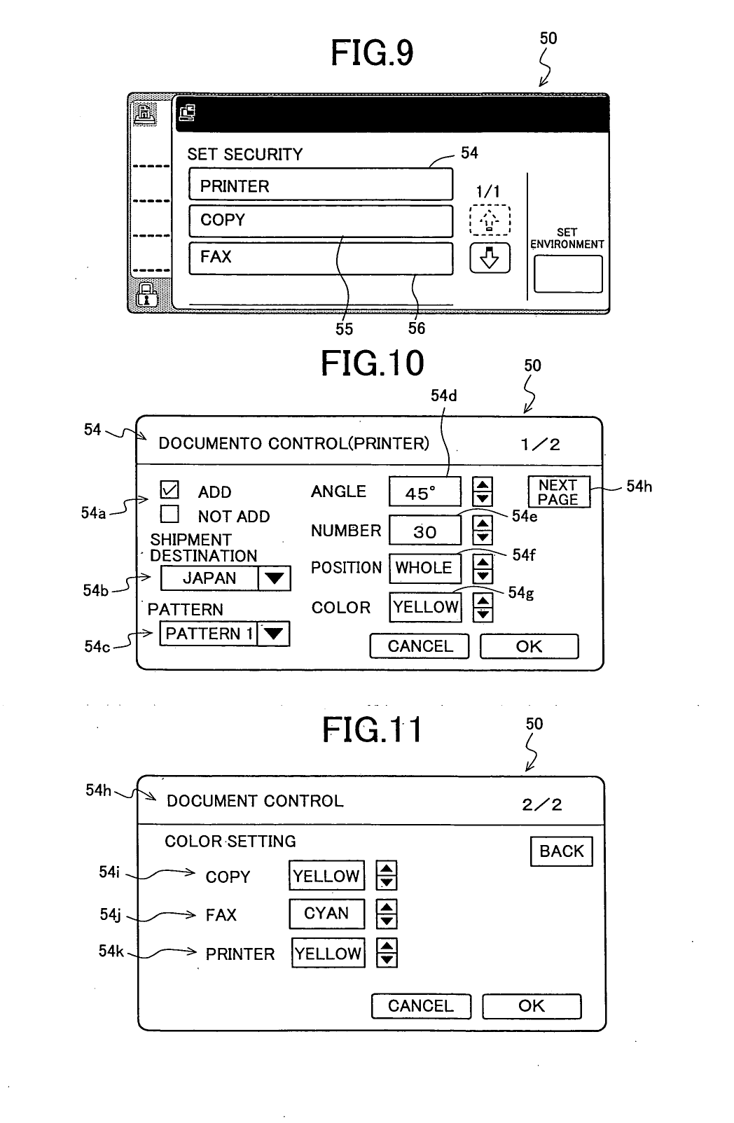

When a user depresses the area 52 for transition to the key operator program on the displayed screen 50 of FIG. 6, various setting items such as section management, energy saving setting, operation setting, system management setting, copy setting, fax/image transmission setting, list/report print, key-operator code change and product key input as well as an area 53a for security setting are displayed. When an administrator user depresses the area 53a for security setting, a password entry area 53b is popped-up like the display screen 50 of FIG. 8. When the manager user enters a password by the ten-key pad 41 and the like on this screen, the screen is changed to a security setting screen as is exemplarily shown by a display screen 50 in FIG. 9.

FIGS. 9 through 11 show screens for setting characteristics of the specific image information. A printer selecting area 54, copy selecting area 55 and fax selecting area 56 are displayed on the security setting screen of FIG. 9. For example, when a user depresses the printer selecting area 54, the screen is changed to a display screen shown in FIG. 10.

A display screen 50 (GUI screen example) shown in FIG. 10 displays items for setting setup conditions of characteristics of the specific image information as a document control for the printer. In this example, the items are a pull down box 54b for selecting a shipment destination (shipment destination indicating what country or region the digital MFP 1 is shipped to), an angle input field 54d, a number (number indicating how many sets of the specific image information are added) input field 54e, a position (position indicating what position on an original document the specific image information is added) input field 54f, a color (color indicating what color the specific image information is added in) input field 54g, and a next page button 54h for proceeding to the next page. The example of FIG. 10 also includes check boxes 54a for setting whether to add the specific image information and a pull down box 54c for selecting which the specific image information (specific pattern) is to be added.

The check boxes 54a are setting fields for setting whether to add the specific image information, and thus, the specific image information setting portion 20c preferably includes an additional condition setting portion that sets an additional condition (input source and/or recording destination, etc.) for determining whether to add the specific image information by the specific image information adding portion 20b. The additional condition setting portion may also be realized by the additional condition managing portion 17b of FIG. 2, etc. With regard to the setting field like the check boxes 54a, a corresponding field may be checked with a printer driver of a PC, may be operated with the operation portion 12 of the device, or may be operated manually.

Such an additional condition may be set automatically and, for example, whether the addition is performed may be decided based on the input source and/or recording destination or based on determining whether a confidential process is performed or determining whether an output material (printed material, etc.) is output by a user at a certain access right level when the access right is checked through the user authentication. For example, when a manager prints an original document, it is automatically determined that the original document is important and an additional image is automatically added, or when output is suspended once and then performed after waiting for input of a password, etc., i.e., when a hold-print function (confidential print function) is used, it is determined that the original document should not be read by others and an additional image is automatically added.

The angle input field 54d is a setting field for inputting, or selecting and inputting, an angle different from an angle of lines assumed to be included mainly in the image data to add a line or lines with the input angle as the specific image information. Since the present invention can add angled lines and many documents include ruled lines and pictures in Japan although few documents include ruled lines overseas, the specific image information is added as lines with an angle of 45 degrees to prevent ruled lines or the like from being misrecognized as a mark and prevent a copy machine from being stopped when the ruled lines or the like are repeatedly copied and scratched. Actually, although ruled lines and underlines or deletion lines of characters appear frequently in a document, few lines have an angle. In that respect, angled lines may be used as a mark to prevent the misrecognition from occurring when texts are scratched. Since line images such as vertical lines and horizontal lines are frequently included as characteristics of an original document, the angled lines are correspondingly added as the additional images such that the angled lines do not overlap the line images. The present invention preferably includes a portion that sets the condition (angle) for adding the image such that the characteristics do not overlap each other.

The shipment destination input field 54b is a setting field for inputting (selecting and inputting) a destination (area where the digital MFP 1 is used), and the input destination is linked to an angle of the specific image information specified by a vendor in advance and enables the angle to be set indirectly when the destination is set without setting the angle. For example, since few ruled lines are used in United States, this destination may be linked to an angle slightly smaller than 45 degrees. The aforementioned characteristic setting portion preferably includes a portion that sets a characteristic not overlapping the predefined characteristic correspondingly to the setting of the usage area of the image processing apparatus to add the specific image at an angle depending on destinations such that the characteristics do not overlap each other.

The number input field 54e is a field for inputting, or selecting and inputting, the number of sets (M+N described above) of the specific image information and may also be used to set the number of M described above, which corresponds to a detection level for invalidating an image. The detection may be performed based on a distance or positional relationship between one type of the specific image information (mark) as well as the number. For example, if a user selects a photograph mode for copying, an administrator may be able to perform initial setup for reducing a percentage, detecting whether a predetermined number of patterns exist, or detecting whether a predetermined number (such as three) of patterns exist at constant intervals.

The position input field 54f is a field for selecting and setting a position where the specific image information is added. The position may be selected and set from a whole area, four corners, both ends, outer frame, etc. The specific image information is added to a whole area (whole surface) so as to support the detection of the mark and the copy protection based on the detection even when a part of a printed paper sheet is clipped and copied.

In the color input field 54g, a user can select a color of the specific image information from a plurality of colors. A display screen 50 shown in FIG. 11 includes items for setting the color, which are a copy color input field 54i, a FAX color input field 54j, a printer color input field 54k, and a button for returning to the previous page (the GUI screen 50 in FIG. 10). The colors can be set depending on input modes such as copy mode, fax mode, and printer mode.

Although not shown, a job setting field may be included to change an added angle depending on a job. For example, since it is assumed that many angled lines are used in a copying machine utilized by a designer, a straight line may be used in some cases or a set of marks may be formed by combining lines with a plurality of angles.

When a user depresses a next page button 54h of the display screen 50 in FIG. 10, the display screen is changed to a document control screen 54h of the screen 50 of FIG. 11. On the document control screen 54h, setting of colors is possible for each of copy, fax and printer. It is preferable that other functions of copy and fax can be set on similar screen. Description of them will be omitted since the setting operation is substantially identical.

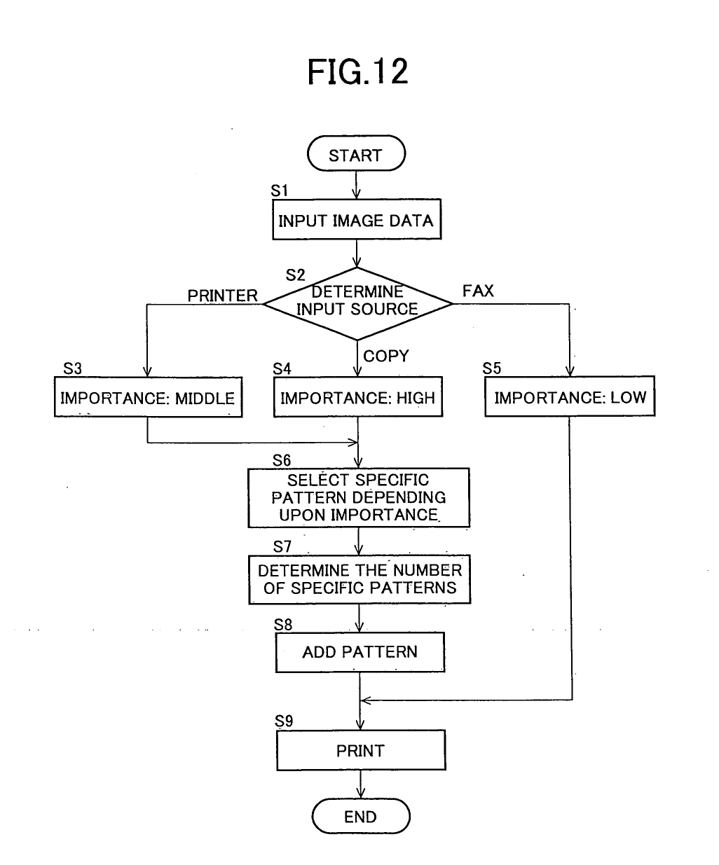

FIG. 12 is a flow chart for explaining an example of a specific image information adding process in the image processing apparatus of FIG. 1. An example of a specific image information adding process which is a result of the user operation which is exemplarily shown in FIGS. 5 through 11 will be described with reference to FIG. 12. Only an example of a method of making a method of adding specific image information different depending upon only the input source (actually one function in which the input source is linked with the recording destination) is shown. Description of other examples will be omitted. For all input sources and/or recording destinations, the processing can be similarly described.

Firstly, the image input portion inputs image data (step S1) The specific image information adding portion 20b determines the input source of the image data (step S2). If the input source is a printer, the importance is set to “middle” (step S3). If the input source is a copy, the importance is set to “high” (step S4). If the input source is FAX, the important is set to “low” (step S6). If the importance is set to “low”, the adding process of specific image information is not executed and printing is carried out (step S9).

If the importance is set to “middle” or “high”, the specific image information adding portion 20b selects specific patterns depending upon its importance (step S6) and determines the number of the specific patterns (step S7) After steps S6 and S7, the specific image information adding portion 20b adds the specific patterns which are determined at steps S6, S7 (step S8) for conducting printing (step S9). Addition/non-addition of specific patterns and their kinds for the input source which is determined at step S2 may be determined directly at step S6 for executing the process without setting the importance at steps S3 through S5.

The machine control portion 14 described in FIG. 1 will be described complementarily. The control portion 14 of FIG. 1 actually includes a processing unit such as CPU and MPU, a ROM (preferably, a rewritable ROM) that stores firmware including a specific image information adding program, a RAM that is an execution area used when the processing unit reads out and executes the firmware, etc. In this way, the present invention can employ a form of a specific image information adding program. This program may be a program for allowing the processing unit to execute at least the specific image information addition according to the embodiment. That is, the program is incorporated into the image forming apparatus such as the digital MFP 1 or other image processing apparatuses to allow the processing unit in the apparatus to function as the specific image information adding portion 20b described above as well as other aforementioned portion such as the specific image information setting portion 20c, the specific image information detecting portion 20a, the image modifying portion, a part of the image reading portion, and the image invalidating portion.

The program of the present invention will be stored in a computer readable recording medium together with data if needed and is distributed or delivered via a network. Such a recording medium may include CD-ROM, opto-magnetic disk, DVD-ROM, FD, flash-memory and other various ROMs and RAMs. Implementing of functions of the present invention is made easier by distributing recording media storing the above programs therein. The program may be stored so that it can be executed in the image processing apparatus by mounting the above-mentioned recording medium on the information processing apparatus such as computer to read out the program with the image processing apparatus and by transferring the read out program to a control portion of the image processing apparatus. The functions of the present invention can be performed by reading out the stored program if needed.

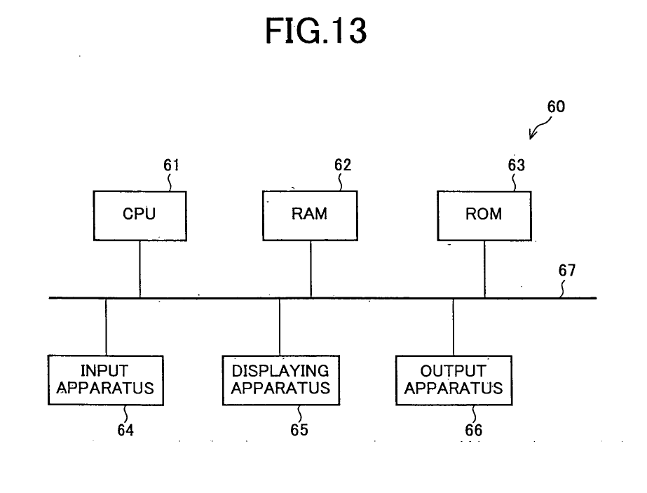

Description will be made of an example of the machine control portion 14, which is a configuration example of a typical information processing apparatus including the machine control portion 14 as shown in FIG. 13. Main components of an information processing apparatus 60 include: an input apparatus 64 for inputting various pieces of information, such as a keyboard, a mouse, a recording medium reading apparatus, and a network device for input from other devices; a displaying apparatus 65 as a display for displaying various pieces of information (which may be combined with the input apparatus 64 to constitute a touch panel), such as a CRT (Cathode-Ray Tube), an LCD (Liquid Crystal Display), and a PDP (Plasma Display Panel); an output apparatus 66, such as a communicating apparatus, for example, a network connecting apparatus (a communication device such as a network board for connecting with and communicating through a network), a printing apparatus, and an external output apparatus, for example, a recording apparatus for a recording medium; a hard disk or ROM 63 that records a program of the present invention; a CPU 61 for executing the stored program; and a RAM 62 used for the execution area, and these components are connected with a bus 67 in the illustration. The program may include a GUI for the display apparatus 65 such that a user can easily use the program at the time of various settings. The information handled in these apparatuses is accumulated temporarily in the RAM 62 when processed and is then stored in the ROM 63 or hard disk, and the CPU 61 reads out the information for modification and rewrites as needed.

As mentioned above, when specific image information used to prohibit copying of image information is added to image data, the present invention makes it possible to add the specific image information only for cases where the addition is desired and to output the specific image information added image.

1. An image processing apparatus comprising:
an image input portion for inputting image data;
a specific image information adding portion for adding one or more sets of specific image information representing a specific image when the image data input from said image input portion is subjected to image processing; and
an image recording portion for recording on a recording medium the image data which has been added with said specific image information at said specific image information adding portion,
wherein said specific image information adding portion makes a state after an adding process different depending upon an input source in said image input portion and/or a recording destination in said image recording portion.

2. An image processing apparatus as defined in claim 1, wherein said specific image information adding portion makes said state after said adding process different depending upon whether or not said specific image information is to be added.

3. An image processing apparatus as defined in claim 1, wherein said specific image information adding portion makes one or more of a color, number and position of said specific image information different as said state after said adding process.

4. An image processing apparatus as defined in claim 1, wherein said specific image information adding portion makes a kind of said specific image information different as said state after said adding process.

5. An image processing apparatus as defined in claim 1, wherein said state after said adding process is determined based upon the importance of the image data input at said image input portion.

6. An image processing apparatus as defined in claim 1, wherein said image recording portion includes a proxy processing portion which requests other image processing apparatus connected to said image processing apparatus to execute recording when said image recording portion is not able to execute said recording by itself, said proxy processing portion being adapted to select said other image processing apparatus from a plurality of image processing apparatuses based upon said input source.

7. An image processing apparatus as defined in claim 1, wherein said image recording portion includes a proxy processing portion which requests other image processing apparatus connected to said image processing apparatus to execute recording when said image recording portion is not able to execute said recording by itself, said specific image information adding portion being adapted to execute said addition of said specific image information regardless of a recording destination to which said proxy processing portion requests said recording.

8. An image processing apparatus as defined in claim 1, wherein if a plurality of recording destinations are set in said image recording portion to one piece of the image data input at said input portion, said specific image information adding portion being adapted to make said state after said adding process common among said plurality of recording destinations.

9. An image processing apparatus as defined in claim 1, wherein said image recording portion includes an image storing portion for storing in a recording medium the image data input at said image input portion, said specific image information adding portion being adapted to add said specific image information to the image data stored in said image storing portion so that said image data and said specific image information is stored as one set of information in said image storing portion.

10. An image processing apparatus as defined in claim 1, wherein said apparatus comprises a specific image information setting portion which sets said state after said adding process for each of said input sources and/or said recording destinations, said specific image information adding portion executing the addition of said specific image information based upon setting at said specific image information setting portion.

11. An image processing method in an image processing apparatus comprising an image input portion for inputting image data; an image processing portion which applies an image process to the image data; and an image recording portion for recording the image data on a recording medium, wherein said method includes the steps of:
an image input step for inputting the image data by said image input portion;
a specific image information adding step for adding one or more sets of specific image information representing a specific image when said image processing portion applies said image process to the image data input at said image input step; and
an image recording step for recording the image data which is added with said specific image information at said specific image information adding step on a recording medium by means of said image recording portion,
wherein a state after an adding process is made different depending upon an input source in said image input portion and/or a recording destination in said image recording portion at said specific image information adding step.

12. A program which is incorporated in said image processing apparatus as defined in any one of claims 1 through 10 to cause a processing unit in said image processing apparatus to function as said specific image information adding portion or said specific image information adding portion and said specific image information setting portion.
